(19) United States
(12) Patent Application Publication
(10) Pub. No.: US 2009/0096585 A1
(43) Pub. Date: Apr. 16, 2009

(54) Methods, Systems and Apparatus for Radio Frequency Identification (RFID) System Configuration Management

(75) Inventors: Allan Perry Herrod, Mission Viejo, CA (US); Steven Lee Zimmerman, Minnetonka, MN (US); Paul Alexander Cowan, Humble, TX (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 11/871,748

(22) Filed: Oct. 12, 2007

(51) Int. Cl. H04B 7/00; H04Q 5/22

(52) U.S. Cl. 340/10.2

(57) ABSTRACT

Methods, systems and apparatus for controlling initiation of configuration of RFID readers using initiate-staging control information, include interrogating a reading zone of a reader for initiate-staging control information, and selectively setting the reader in an initiate-staging state in accordance with initiate-staging control information detected by the interrogation. The interrogation may include interrogating at least one RFID tag located in the reading zone of the reader for initiate-staging control information stored therein. The interrogation may include interrogating a reading zone of the reader for initiate-staging control information only during a predetermined period of time T_{ISC}, e.g., after power-up of the reader.

### BACKGROUND OF THE INVENTION

1. Field of the Invention

The present invention relates to radio frequency identification (RFID) methods, systems and tags, and more particularly to methods, systems and apparatus to initiate staging for configuration of an RFID reader.

2. Background

Radio frequency identification (RFID) readers tend to be unique devices to manage within a system. It is common for the same model of RFID reader to be implemented for different uses within a single system, with each reader being configured differently. Each mobile reader typically is configured based on the role of its user, e.g., shipping clerk, inventory taker, etc. Each fixed-location reader typically is configured based on its location, e.g., proximate main entrance, proximate loading dock, proximate file room, etc. Accordingly, readers commonly require custom configuration for their intended use.

Custom configuration may be difficult to achieve due to the lack of a rich, efficient, user-friendly user interface. RFID readers typically are “headless”—that is, they seldom have a visual display, keyboard/mouse or other interface for a user to interact with, particularly when configuring, or re-configuring, a particular device for a particular application within an enterprise. This may result in errors in configuration or re-configuration of a reader. Configuration errors may result in undesirable system failure, loss in productivity and/or security violations of premises protected by RFID readers.

Commonly owned U.S. patent application Ser. No. 11/589,992, filed Oct. 31, 2006 and titled “Using RFID Tags to Configure Initialized Fixed Station RFID Tag Readers” (Subramanian, et al.), incorporated by reference herein in its entirety, discloses an approach for addressing such drawbacks in RFID system configuration staging. This approach uses an RFID tag to store configuration information that may be transferred by interrogation to an RFID reader, where the initial configuration of the RFID reader may be capable only of interrogating an RFID tag, and where the configuration information transferred to the RFID reader may be either configuration information per sé or information directing the reader to a further source of configuration information, such as a profile server.

This approach has advantages in many applications. However, this approach has an inherent limitation in applications that use RFID tags having limited memory capacity, or applications that use RFID tags having memory capacity insufficient to encode adequate configuration information for a given system. For example, conventional Gen-2 RFID tags often have 96 bits or less of memory space available for such configuration information, and therefore may store insufficient configuration information for configuring a given system. The '992 application teaches an approach for overcoming such limitation by storing information directing a reader to a further source of configuration information, such as a profile server.

This approach also may have a drawback in systems including readers having overlapping broadcast/reading zones. Bringing an RFID tag containing configuration information into a reading zone of one reader in a system also may bring the RFID tag into the reading zone of one or more other readers within the system. In this case, a user must take care not to inadvertently or unintentionally configure or re-configure one or more of such other readers.

### SUMMARY

The present invention generally relates to methods, systems and apparatus for controlling initiation of staging/configuration of RFID readers using initiate-staging control information.

In one aspect, embodiments include a method of controlling staging for configuration of a radio frequency identification (RFID) reader comprising interrogating a reading zone of the reader for initiate-staging control information, and selectively setting the reader in an initiate-staging state in accordance with initiate-staging control information detected by the interrogation. In an embodiment, the interrogation may include interrogating at least one RFID tag located in the reading zone of the reader for initiate-staging control information stored therein. In an embodiment, the interrogation may include interrogating a reading zone of the reader for initiate-staging control information only during a predetermined period of time T_{ISC}, e.g., a predetermined time T_{ISC} after power-up of the reader or a predetermined time T_{ISC} after initiation of staging.

### BRIEF DESCRIPTION OF THE DRAWINGS/FIGURES

The accompanying drawings, which are incorporated herein and form a part of the specification, illustrate embodiments of the present invention and, together with the written description, further serve to explain the principles of the invention and to enable a person skilled in the art to make and use the invention.

FIG. 1 schematically illustrates an exemplary RFID system.

FIG. 2 is a block diagram schematically illustrating an exemplary RFID reader.

FIG. 3 schematically illustrates in plan view an exemplary RFID tag.

FIG. 4 is a flowchart illustrating exemplary steps of an INITIATE-STAGING operation of an RFID reader of the present invention.

FIG. 5 is a flowchart illustrating exemplary steps for a FORCE-RESTAGING operation of an RFID reader of the present invention.

FIG. 6 is a flowchart illustrating exemplary steps for a STAGING-LOCKOUT operation of an RFID reader of the present invention.

FIG. 7 is a flowchart illustrating exemplary steps for combined INITIATE-STAGING, FORCE-RESTAGING and STAGING-LOCKOUT operations in an RFID reader of the present invention.

FIG. 8 is a flowchart illustrating exemplary steps for combined AUTHENTICATION, INITIATE-STAGING, FORCE-RESTAGING and STAGING-LOCKOUT operations in an RFID reader of the present invention.

FIG. 9 is a flowchart illustrating exemplary steps of a LOCATION-ID operation of an RFID reader of the present invention.

Embodiments of the present invention will be described with reference to the accompanying drawings, wherein like reference numbers designate like or similar elements or features. The drawing in which an element first appears typically is indicated by the leftmost digit in the corresponding reference number.

### DETAILED DESCRIPTION OF EMBODIMENTS

### Introduction

The present specification discloses one or more embodiments that incorporate features of the claimed invention. The disclosed embodiment(s) merely exemplify the claimed invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### EXAMPLE RFID SYSTEM EMBODIMENT

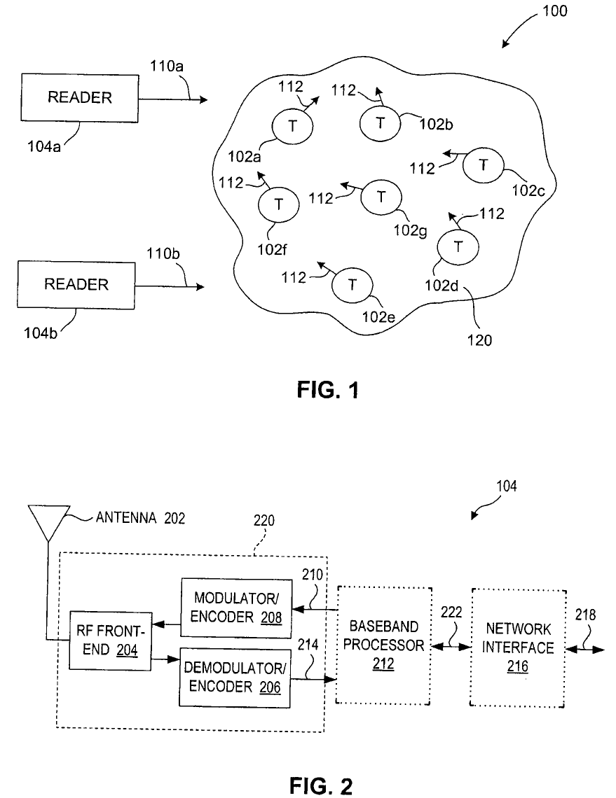

Before describing embodiments of the present invention in detail, it is helpful to describe an example RFID communications environment in which the invention may be implemented. FIG. 1 illustrates an environment 100 where an RFID tag reader 104 communicates with an exemplary population 120 of RFID tags 102. As shown in FIG. 1, the exemplary system includes two readers 104a-104b, and the population 120 of tags includes seven tags 102a-102g. A system may include any number of readers 104, and a population 120 may include any number of tags 102.

Environment 100 includes one or more readers 104. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, reader 104 transmits an interrogation or write signal 110 having a carrier frequency to the population of tags 120. Reader 104 operates in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104 receive and obtain data from response signals 112, including but not limited to an identification number of the responding tag 102. In the embodiments described herein, a reader may be capable of communicating with tags 102 according to any suitable communication protocol, including binary traversal protocols, slotted aloha protocols, Class 0, Class 1, EPC Gen 2, any others mentioned elsewhere herein, and future communication protocols.

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation or write request by reader 104. For example, an interrogation or write request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation or write operation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation or write request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

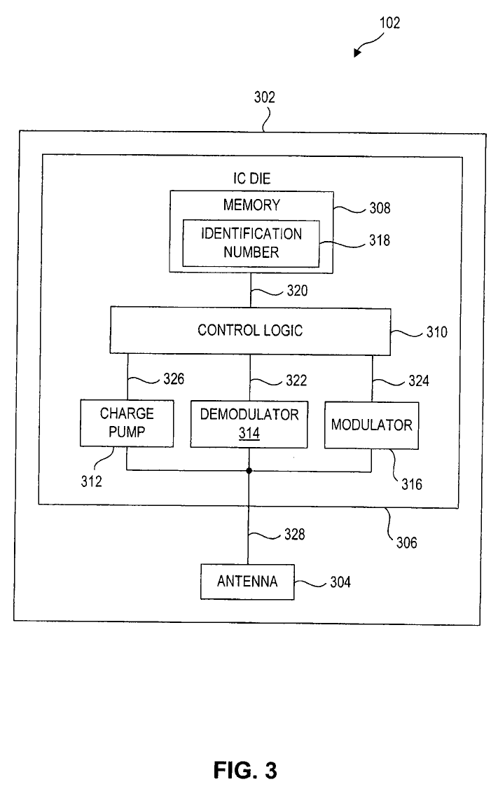

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but alternatively may be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

### Identification Number

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1”or a logical “0”(of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Modulator 316 and demodulator 314 may be referred to collectively as a “transceiver” of tag 102.

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. Another example form of a “tag” is a tag inlay that has been attached to another surface, or between surfaces, such as paper, cardboard, etc., for attachment to an object to be tracked, such as an article of clothing, etc.

Example embodiments of the present invention are described in further detail below. Such embodiments may be implemented in the environments, readers, and tags described above, and/or in alternative environments and alternative RFID devices.

### Proposed Exemplary Embodiments

### Initiate-Staging

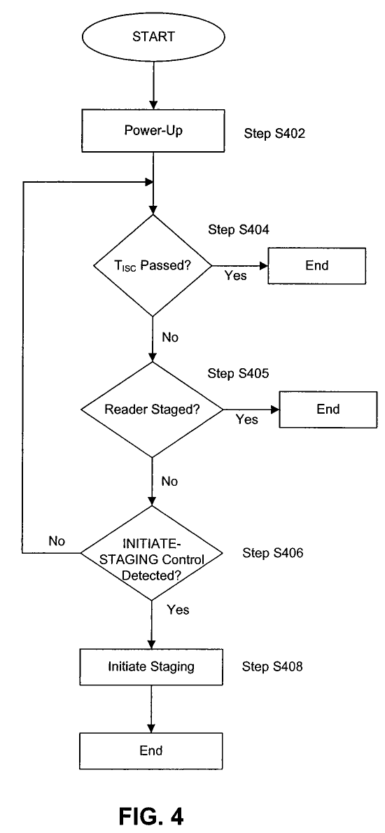

In a proposed exemplary embodiment of an initiate-staging control operation of the present invention, FIG. 4 is a flowchart illustrating exemplary steps for an INITIATE-STAGING operation. The exemplary process starts when the reader 104 is turned ON. When the reader 104 is turned ON, at step S402 the processor 212 begins to execute a power-up procedure. At step S404, the processor 212 determines if a predetermined period of time T_{ISC} for detecting initiate-staging control information has passed since the power-up procedure was initiated. If YES, then the process terminates at END. If NO, then at step S405, the processor 212 determines if the reader 104 already is staged (e.g., already is configured for a system). If YES, then the process terminates at END. If NO, then at step S406, the processor 212 determines if INITIATE-STAGING control is detected. In a proposed exemplary embodiment, the processor 212 may cause the reader 104 to interrogate any RFID tags 102 in a reading zone of the reader 104 and determine if an RFID tag 102 containing INITIATE-STAGING control information is detected in the reading zone. If NO (INITIATE-STAGING control not detected), then the process returns to step S404 to again determine if the time T_{ISC} has passed. It will be appreciated that this process loop may be repeated for a time T_{ISC} if no INITIATE-STAGING control is detected. If the decision in step S406 is YES (INITIATE-STAGING control detected), then at step S408 the processor 212 sets the reader 104 in the initiate-staging state, thereby enabling the reader 104 to begin executing a separate reader configuration staging process. In a proposed exemplary embodiment, the processor 212 may set an INITIATE-STAGING flag in the reader 104. Thereafter, the initiate-staging process terminates at END.

In this manner, it will be appreciated that a reader may be shipped in an “unstaged” state (e.g., from the factory “fresh from the box”, from repair, or from backup storage) and automatically may be set to an initiate-staging state as part of a power-up procedure simply by locating an RFID tag containing INITIATE-STAGING control information in the reading zone of the reader. In an exemplary embodiment, an “unstaged” state is equivalent to the “RDB4” flag of a Gen-2 compliant reader being unset. In a case where an RFID reader previously has been “staged”/configured (e.g., where an RFID reader previously has been in use in a system) and is subjected to an inadvertent power failure or power cycling, it will be appreciated that the RFID reader will not honor INITIATE-STAGING control.

Those skilled in the art readily will appreciate that the time period T_{ISC} for a given application may be set to any time sufficient to permit a reader to automatically execute a desired initiate-staging operation, without having a reader subject to inadvertent or undesired staging or restaging thereafter.

### Force-Restaging

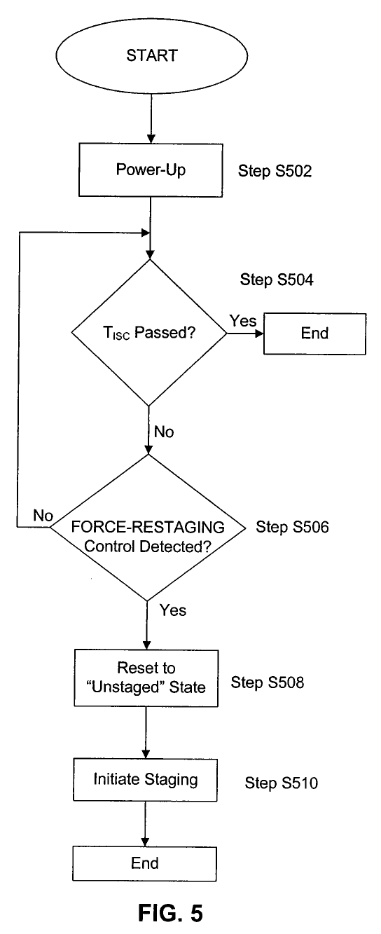

In another proposed exemplary embodiment of an initiate-staging control operation of the present invention, FIG. 5 is a flowchart illustrating exemplary steps for a FORCE-RESTAGING operation. The exemplary process starts when the reader 104 is turned ON. When the reader 104 is turned ON, at step S502 the processor 212 begins to execute a power-up procedure. At step S504, the processor 212 determines if a predetermined period of time T_{ISC} for detecting initiate-staging control information has passed since the power-up procedure was initiated. If YES, then the procedure terminates at END. If NO, then at step S506, the processor 212 determines if FORCE-RESTAGING control is detected. In a proposed exemplary embodiment, the processor 212 may cause the reader 104 to interrogate any RFID tags 102 in a reading zone of the reader 104 and determine if an RFID tag 102 containing FORCE-RESTAGING control information is detected in the reading zone. If NO (FORCE-RESTAGING control not detected), then the process returns to step S504 to again determine if the time T_{ISC} has passed. It will be appreciated that this process loop may be repeated for the time T_{ISC}. If the determination at step S506 is YES (FORCE-RESTAGING control detected), then at step S508 the processor 212 may re-set the reader 104 to an unstaged state. In a proposed exemplary embodiment, the processor 212 may re-set a “staged” flag in the reader 104. In step S510 the processor 212 then sets the reader 104 in the initiate-staging state, thereby enabling the reader 104 to begin executing a separate reader configuration staging process. In a proposed exemplary embodiment, the processor 212 may set an INITIATE-STAGING flag in the reader 104. Thereafter, the FORCE-RESTAGING process terminates at END.

In this manner, it will be appreciated that a previously staged reader automatically may be re-set to an initiate-staging state as part of a power-up procedure simply by locating an RFID tag containing FORCE-RESTAGING control information in the reading zone of the reader.

### Staging-Lockout

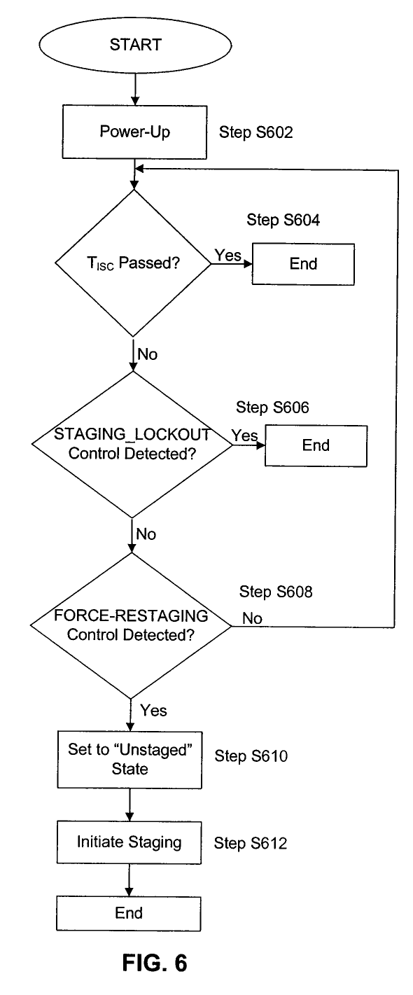

In another proposed exemplary embodiment of an initiate-staging control operation of the present invention, FIG. 6 is a flowchart illustrating exemplary steps for a STAGING-LOCKOUT operation. The exemplary process starts when the reader 212 is turned ON. When the reader 104 is turned ON, at step S602 the processor 212 begins to execute a power-on procedure. At step S604, the processor 212 determines if a predetermined period of time T_{ISC} for detecting initiate-staging control information has passed since the power-up procedure was initiated. If YES, then the process terminates at END. If NO, then at step S606 the processor 212 determines if STAGING_LOCKOUT control is detected. In a proposed exemplary embodiment, the processor 212 may cause the reader 104 to interrogate any RFID tags 102 located in a reading zone of the reader 104 and determine if an RFID tag 102 containing STAGING_LOCKOUT control information is detected in the reading zone. If YES (STAGING_LOCKOUT control detected), the process is terminated at END. If NO (STAGING_LOCKOUT control not detected), then at step S608 the processor 212 determines if FORCE-RESTAGING control is detected. In a proposed exemplary embodiment, the processor may cause the reader 104 to interrogate any RFID tags 102 located in a reading zone of the reader 104 and determine if an RFID tag 102 containing FORCE-RESTAGING control information is detected in the reading zone. If NO, then the process returns to step S604 to again determine if the time T_{ISC} has passed. It will be appreciated that this process loop may be repeated for a time T_{ISC} if no STAGING_LOCKOUT or FORCE-RESTAGING control is detected. If the determination at step S608 is YES (FORCE-RESTAGING control detected), then at step S610 the processor 212 re-sets the reader 104 to the unstaged state. In a proposed exemplary embodiment, the processor 212 may re-set a “staged” flag in the reader 104. At step S612 the processor 212 then sets the reader 104 in the initiate stating state. In an exemplary embodiment, the processor 212 may re-set an INITIATE-STAGING flag in the reader 104. Thereafter, the process terminates at END.

In this manner, it will be appreciated that a reader that previously has been properly staged/configured for a system automatically may be prevented from re-setting itself to an initiate-staging state, even during power cycling or a power up procedure, simply by locating a STAGING_LOCKOUT control tag in the reading zone of the reader.

### Multi-State Initiate-Staging Control

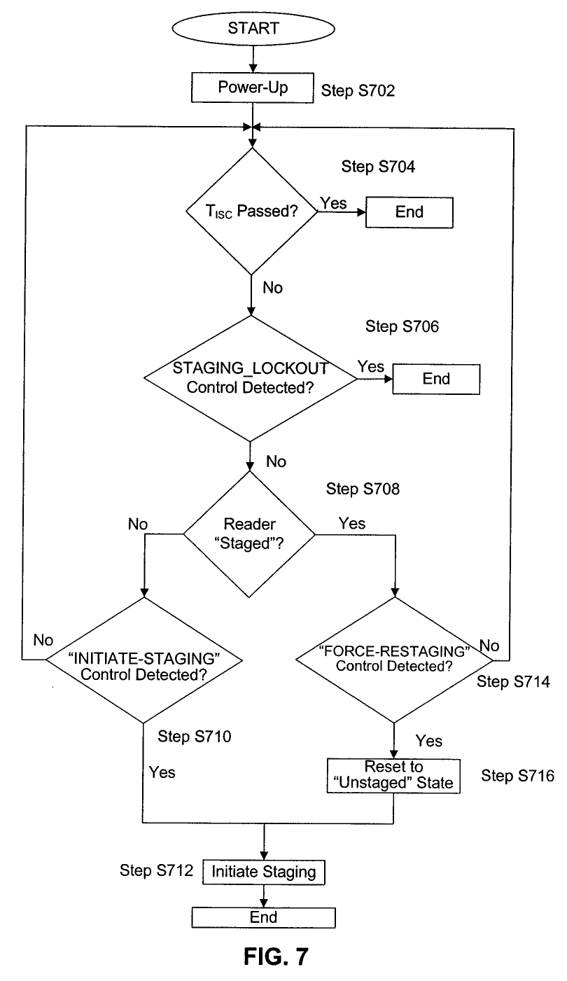

In another proposed exemplary embodiment of an initiate-staging operation of the present invention, FIG. 7 is a flowchart illustrating exemplary steps for selective, combined INITIATE-STAGING, FORCE-STAGING and STAGING-LOCKOUT operation. The exemplary process starts when the reader 104 is turned ON. When the reader 104 is turned ON, at step S702 the processor 212 begins to execute a power-up procedure. At step S704, the processor 212 determines if a predetermined time T_{ISC} for detecting initiate-staging control information has passed since the power-up procedure was initiated. If YES, then the process terminates at END. If NO, then at step S706 the processor determines if STAGING_LOCKOUT control is detected. In a proposed exemplary embodiment, the processor 212 may cause the reader 104 to interrogate any RFID tags 102 located in a reading zone of the reader 104 and determine if a (first) RFID tag 102 containing STAGING_LOCKOUT control information is detected in the reading zone. If YES (STAGING_LOCKOUT control detected), then the process terminates at END. If NO (STAGING_LOCKOUT control not detected), then at step S708 the processor 212 determines if the reader 104 is already in a “staged” state. If NO, then at step S710 the processor 212 determines if INITIATE-STAGING control is detected. In a proposed exemplary embodiment, the processor 212 may cause the reader 104 to interrogate any RFID tags 102 located in the reading zone of the reader 104 and determine if a (second) RFID tag 102 containing INITIATE-STAGING control information is detected in the reading zone. If NO (INITIATE-STAGING control not detected), then the process returns to step S704 to again determine if the time T_{ISC} has passed. It will be appreciated that this process loop may continue for a time T_{ISC} if no STAGING_LOCKOUT and INITIATE-STAGING control is detected. If the determination at step S710 is YES (INITIATE-STAGING control detected), then at step S712 the processor 212 sets the reader 104 in the initiate-staging state, thereby enabling the reader 104 to begin executing a separate reader configuration staging process. On the other hand, if the determination in step S708 is YES (reader is in “staged” state), then at step S714 the processor 212 determines if FORCE-RESTAGING control is detected. In a proposed exemplary embodiment, the processor 212 may cause the reader 104 to interrogate any RFID tags 102 in the reading zone of the reader 104 and determine if a (third) RFID tag 102 containing FORCE-RESTAGING control information is detected in the reading zone. If NO (FORCE-RESTAGING control not detected), then the process returns to S704 to again determine if the time T_{ISC} has passed. It will be appreciated that this process loop may be repeated for a time T_{ISC} if no STAGING_LOCKOUT and FORCE-RESTAGING control is detected. If the decision in step S714 is YES (FORCE-RESTAGING control detected), then at step S716 the processor 212 re-sets the reader 104 to the “unstaged” state. In a proposed exemplary embodiment, the processor 212 may re-set a “staged” flag in the reader 104. At step S712, the processor 212 sets the reader 104 to the initiate-staging stage. Thereafter, the initiate-staging process terminates at END.

In this manner, it will be appreciated that a reader automatically may be controlled to prevent forced restaging during power cycling or an inadvertent power outage, and yet to set or re-set itself to an initiate-staging state during a power-up procedure simply by removing a staging-lockout control tag from the reading zone of the reader and then locating a desired initiate-staging control tag in the reading zone of the reader.

Initiate-Staging with Authentication

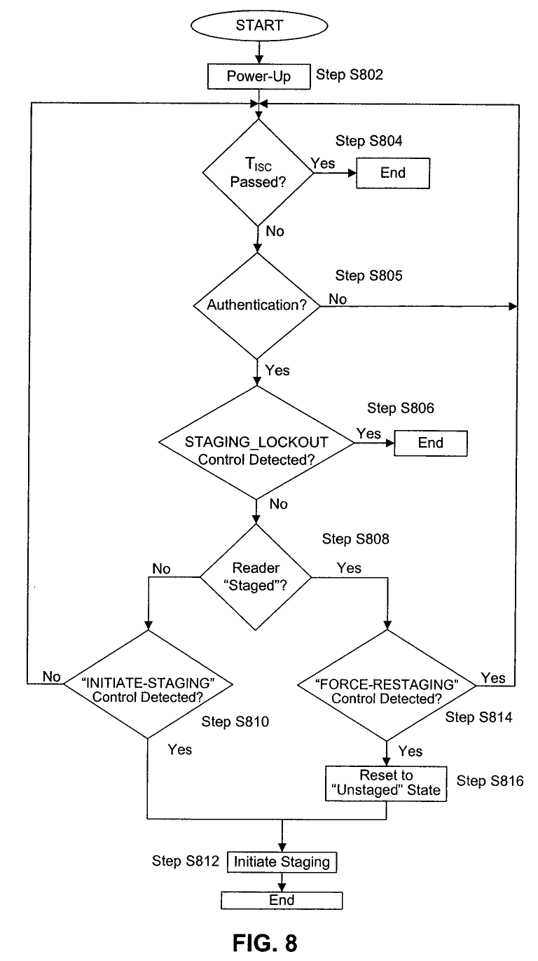

In another proposed exemplary embodiment of an initiate-staging control operation of the present invention, FIG. 8 is a flowchart illustrating exemplary steps for combined AUTHENTICATION, INITIATE-STAGING, FORCE-STAGING and STAGING-LOCKOUT operations. In an exemplary embodiment, this process may be implemented using separate tags for each of these control operations, similar to the operations described above in FIG. 7. Alternatively, in exemplary embodiments, this process may be implemented using a single RFID tag 102 that is configured to selectively change the initiate-staging control information stored in its memory 308 and/or transmitted in response to interrogation. In proposed exemplary embodiments, the initiate-staging control information stored in the RFID tag 102 may be changed automatically or manually by a user, e.g., using interrogation and write commands from a reader; the interrogation and write commands may be any proprietary or standard protocol, e.g., Gen-2 standard protocol. Those skilled in the art readily will recognize alternative methods, systems and protocol for enabling/controlling an RFID tag 102 to change control information stored therein and/or transmitted therefrom in response to interrogation by a reader 104.

In proposed exemplary embodiments, a variable control information RFID tag 102 optionally may be shipped together with the reader 104. For example, this may be done (1) when a reader is shipped after initial manufacture/fabrication, (2) when a reader is taken off-line for service and then returned on-line, or (3) when a reader is brought on-line from a spare parts location. In each case, a reader 104 may be shipped in an “unstaged” state, to facilitate an initiate-staging control operation.

In proposed exemplary embodiments, an RFID tag 102 may be physically associated with a reader 104. For example, the tag 102 may be affixed to a reader 104, integrated into a particular reader 104, removably attached to a reader 104, or simply provided in common or in close proximity with a reader 104. Those skilled in the art readily will be able to determine an appropriate physical association suitable to a desired application.

In proposed exemplary embodiments, an RFID tag 102 optionally may be provided with authentication identification information. For example, a unique identification ID associated with a reader may be stored in the memory of an associated RFID tag (in addition to the RFID tag's own unique ID information) and authenticated/confirmed by interrogation process by that reader prior to any further control communication and processing between the reader and the tag. In an exemplary embodiment, a reader 104 and a tag 102 may have an exclusive pairing. For example, a reader 104 may be paired with only a single tag 102 that is capable of changing its initiate-control information. Alternatively, a reader 104 may be exclusively paired with a set of tags 102, including one INITIATE-STAGING tag, one FORCE-RESTAGING tag, one STAGING_LOCKOUT tag, etc. Those skilled in the art readily will be able to select appropriate authentication and pairing suitable for a desired application.

Referring to FIG. 8, in a proposed exemplary embodiment the process starts when a reader 104 is turned ON. When the reader 104 is turned ON, at step S802 the processor 212 begins to execute a power-up procedure. At step S804 the processor 212 determines if a predetermined time T_{ISC} for detecting initiate-staging control information has passed since the power-up procedure was initiated. If YES, then the process terminates at END. If NO, then at step S805, the processor 212 determines if an RFID tag 102 in the reading zone of the reader 104 is authenticated. In a proposed exemplary embodiment, the processor 212 may cause the reader 104 to interrogate any RFID tags 102 located in a reading zone of the reader 104 and determine if an RFID tag 102 in the reading zone contains authentication ID information for that reader 104. If NO (no Authentication), then the process returns to step S804 to again determine if the time T_{ISC} has passed. It will be appreciated that this process loop may be repeated for a time T_{ISC} if no authentication is determined. If YES (Authentication confirmed), then at step S806 the processor 212 determines if STAGING_LOCKOUT control is detected. In a proposed exemplary embodiment, the processor 212 may cause the reader 104 to interrogate an authenticated RFID tag 102 located in the read zone of the reader 104 and determine if the authenticated RFID tag 102 contains STAGING_LOCKOUT control information. If YES, then the process terminates at END. If NO, then at step S808, the processor 212 determines if the reader 104 already is in a “staged” state. If NO, then at step S810 the processor 212 determines if INITIATE-STAGING control is detected. In a proposed exemplary embodiment, the processor 212 determines if the authenticated RFID tag 102 contains INITIATE-STAGING control information. If NO, then the process returns to step S804 to again determine if the time T_{ISC} has passed. It will be appreciated that this process loop may continue for a time T_{ISC} if no authenticated STAGING_LOCKOUT or INITIATE-STAGING control is detected. If the determination at step S810 is YES (INITIATE-STAGING control detected), then at step S812, the processor 212 sets the reader 104 in the initiate-staging state, thereby enabling the reader 104 to begin executing a separate reader configuration staging process. If the determination in step S808 is YES (reader is in “staged” state), then at step S814 the processor 212 determines if FORCE-RESTAGING control is present. In a proposed exemplary embodiment, the processor 212 may determine if the authenticated RFID tag 102 contains FORCE-RESTAGING control information. If NO, then the process returns to S804 to again determine if the time T_{ISC} has passed. It will be appreciated that this process loop may be repeated for a time T_{ISC} if no authenticated STAGING_LOCKOUT or FORCE-RESTAGING control is detected. If the decision in step S814 is YES (FORCE-RESTAGING control detected), then at step S816 the processor 212 re-sets the reader to the “unstaged” state. In a proposed exemplary embodiment, the processor 212 may re-set a “staged” flag in the reader 104, and advance to step S812. At step S812, the processor 212 sets the reader 104 to the initiate-staging state. Thereafter, the initiate-staging process terminates at END.

In this manner, it will be appreciated that a reader automatically may be controlled to authenticate an RFID control tag, to prevent restaging during power cycling or an inadvertent power outage, and to set or re-set itself to an initiate-staging state during a power-up procedure simply by selectively setting desired initiate-staging control information in an authenticated RFID tag located in the reading zone of the reader. It also will be appreciated that, by removing an associated authentication RFID control tag from the reading zone of a reader, the reader can be effectively locked out from any forced restaging during power cycling or an inadvertent power outage. In this case, should the need to restage occur for a specific reader, the associated authentication RFID control tag for the reader need only be re-introduced into the reading zone of the reader, at which time the reader again will accept control from a force-restaging RFID control tag. It will be appreciated that this process enables individualized control over a targeted reader even when the reading zones of other readers overlap the reading zone of the targeted reader.

### Location-ID Staging

In addition to setting a reader in an initiate-staging state, per se, an initiate-staging control operation of the present invention may be used to provide additional staging control information to a reader. For example, in exemplary embodiments an initiate-staging control operation may be used to provide staging control information related to a reader's location in the system. When an RFID reader 104 is delivered to a fixed location in an RFID system, it may require custom configuration for that location. For example, a reader located near a customer entrance/exit door of a store may require custom configuration directed to inventory and/or security functions. An RFID tag 102 including LOCATION-ID information (i.e, a LOCATION-ID tag) may be used to provide basic configuration staging information to the reader.

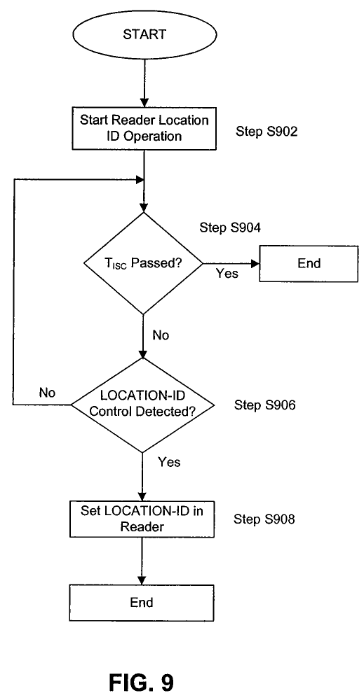

In another proposed exemplary embodiment of an initiate-staging control operation of the present invention, FIG. 9 is a flowchart illustrating exemplary steps for a LOCATION-ID operation. In an exemplary embodiment, the process may start when a reader 104 is set in an initiate-staging stage. When the reader 104 is set in the initiate-staging state, at step S902 the processor 212 may begin to execute a reader location identification (initiate-staging) operation. At step S904, the processor 212 determines if a predetermined period of time T_{ISC} for detecting initiate-staging control information has passed since the location-ID staging process was initiated. If YES, then the process terminates at END. If NO, then at step S906, the processor 212 determines if LOCATION-ID control information is detected. In a proposed exemplary embodiment, the processor 212 may cause the reader 104 to interrogate any RFID tags 102 located in a reading zone of the reader 104 and determine if an RFID tag 102 containing LOCATION-ID control information is detected in the reading zone. If NO (LOCATION-ID control information not detected), then the process returns to step S904 to again determine if the time T_{ISC} has passed. It will be appreciated that this process loop may be repeated for a time T_{ISC} if no LOCATION-ID control information is detected. If the decision in step S906 is YES (LOCATION-ID control information detected), then at step S908 the processor 212 sets the LOCATION-ID control information in the reader 104, thereby enabling the reader 104 to begin executing a further, separate reader configuration staging process to configure the reader 104 for the particular location in the system corresponding to the LOCATION-ID control information. Thereafter, the process terminates at END.

In this manner, it will be appreciated that a reader 104 automatically may be both set in an initiate-staging state and pre-set with additional staging control information, e.g., staging/configuration information directed to a fixed-location of the reader in a desired system configuration, simply by locating one or more RFID tags containing initiation-staging control information in a reading zone of the reader at the designated fixed location. It also will be appreciated that when staging is initiated by a reader, the actual staging performed may vary based on the location information previously set. This could allow a reader installed in one location to be subject to different configuration during staging than a reader installed in a different location, even though both readers initiate staging as a result of the same RFID control tag(s). Further, if a reader is moved to a new location and restaged, it could be automatically subject to new configuration during re-staging if it receives a new location ID due to a different location ID present in the reading zone of the reader at its new location.

As discussed above, the present invention has particular utility in RFID systems in which RFID tags have limited memory capacity, e.g., 96 bits or less. In such a system, the initiate-staging control information in the proposed embodiments may be directed only to identifying that staging should be initiated/started, and optionally designating location or other characteristic staging/configuration information. In this manner, for example, an exemplary follow-on initiate-staging process may begin with a step of “discover a profile server,” from which the reader then may obtain robust configuration information, or information about where such configuration information can be found. Generally, such staging may be used to get a reader to a point where policy-based provisioning can take over, at which point the remaining configuration of the device may be driven by sophisticated server-resident policies.

The present invention also may have utility in RFID systems in which RFID tags have additional memory capacity. As RFID tags evolve to include more memory and functionality, additional information relating to further staging and configuration operations per se may be stored in such RFID tags and read by interrogation to enable more robust staging and configuration operations. Such control tags/information may be honored under the same or similar conditions and process control under which INITIATE-STAGING control information is honored.

While various proposed embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described proposed exemplary embodiments, but should be defined only in accordance with the following claims and their equivalents.

What is claimed is:

1. A method of controlling staging for configuration of a radio frequency identification (RFID) reader, comprising;
interrogating a reading zone of the reader for initiate-staging control information; and
selectively setting the reader in an initiate-staging state in accordance with initiate-staging control information detected by said interrogating.

2. The method of claim 1, said interrogating including:
interrogating at least one RFID tag located in the reading zone of the reader for initiate-staging control information stored therein.

3. The method of claim 1, further comprising:
interrogating a reading zone of the reader for initiate-staging control information only during a predetermined period of time T_{ISC} after power-up of the reader.

4. The method of claim 1, said selectively setting the reader further comprising:
setting the reader in the initiate-staging state in a case where the reader is in an unstaged state and the initiate-staging control information read by the reader is first initiate staging control information (INITIATE-STAGING).

5. The method of claim 1, further comprising;
setting the reader in the initiate-staging state in a case where the reader is in a staged state and the initiate-staging control information read by the reader is second initiate staging control information (FORCE-RESTAGING).

6. The method of claim 1, further comprising:
prohibiting setting of the reader in the initiate-staging state in a case where the initiate-staging control information read by the reader is third initiate staging control information (STAGING_LOCKOUT).

7. The method of claim 1, further comprising:
interrogating the reading zone of the reader for unique location identifier initiate-staging control information, and
staging configuration of the reader with user-defined provisioning policy associated with the unique location identifier staging control information.

8. The method of claim 1, further comprising:
permanently locating an RFID control tag including initiate-staging control information in the reading zone of the reader.

9. The method of claim 8, further comprising:
selectively changing the initiate-staging control information stored in the RFID control tag in accordance with user instructed control.

10. The method of claim 9, further comprising:
selectively changing the initiate-staging control information stored in the RFID control tag to any one of:
first initate staging control information that initiates staging of a reader that is unstaged (INITIATE-STAGING);
second initiate staging contol information that forces restaging of a reader that previously is staged (FORCE-RESTAGING); and
third initiate staging control information that prohibits staging of a reader (STAGING_LOCKOUT).

11. The method of claim 9, further comprising:
storing location information associated with the location of the at least one control tag in memory of the at least one control tag; and
setting a configuration of the reader with user-defined provisioning policy associated with the location information read by the reader.

12. The method of claim 2, further comprising:
exclusively pairing the reader and the at least one control tag.

13. The method of claim 12, further comprising:
physically associating the at least one paired control tag with the reader for shipping immediately post-manufacture of the reader, the reader being shipped in an unstaged state and the control tag having first initiate staging control information (INITIATE-STAGING) stored therein.

14. The method of claim 12, further comprising:
physically associating the at least one paired control tag with the reader for shipping immediately post-service of the reader, the reader being shipped in an unstaged state and the control tag having first initiate staging control information (INITIATE-STAGING) stored therein.

15. A radio frequency identification (RFID) system, comprising:
at least one RFID control tag having initiate-staging control information stored therein; and
an RFID reader operable in an initiate-staging state and configured to control setting of the reader in the initiate-staging state in accordance with the initiate-staging control information stored in the at least one control tag.

16. The system of claim 15, wherein the reader is operable in a staged state and an unstaged state, and
in a case where the reader is in an unstaged state and the initiate-staging control information is first initiate staging control information (INITIATE-STAGING), the reader is set in the initiate-staging state in accordance with the initiate-staging control information;
in a case where the reader is in a staged state and the initiate-staging control information is second initiate staging control information (FORCE-RESTAGING), the reader is set in the initiate-staging state in accordance with the initiate staging control information; and
in a case where the initiate-staging control information read by the reader is third imitate staging control information (STAGING_LOCKOUT), the reader is prohibited from being set in the initiate-staging state in accordance with the initiate staging control information.

17. A radio frequency identification (RFID) reader, comprising:
an antenna;
a transceiver that transmits and receives radio frequency signals via the antenna; and
a processor that controls operation of said transceiver to interrogate a reading zone of the reader for initiate-staging control information, and that selectively sets the reader in an initiate-staging state in accordance with initiate-staging control information detected by interrogating the reading zone.

18. The reader of claim 17, wherein said processor controls operation of said transceiver to interrogate a reading zone of the reader for initiate-staging control information only within a predetermined period of time T_{ISC} after power-up of the reader.

19. A radio frequency identification RFID control tag, comprising:
an antenna, and
an integrated circuit including:
memory that stores data including initiate-staging control information; and
a processor that transmits data via the antenna to an external RFID reader, the data including initiate-staging control information.

20. The RFID control tag of claim 19, wherein the processor is configured to selectively change the initiate staging control information stored in memory.
